(19) United States
(12) Patent Application Publication
(10) Pub. No.: US 2023/0056929 A1
(43) Pub. Date: Feb. 23, 2023

(54) PRECEDING VEHICLE DETERMINING DEVICE AND PRECEDING VEHICLE DETERMINING PROGRAM

(71) Applicant: Mitsubishi Electric Corporation, Tokyo (JP)

(72) Inventors: Saori WADA, Tokyo (JP); Fumiaki TAKAGI, Tokyo (JP); Toshihide SATAKE, Tokyo (JP); Kazuhiro NISHIWAKI, Tokyo (JP); Yuji SHIMIZU, Tokyo (JP)

(73) Assignee: Mitsubishi Electric Corporation, Tokyo (JP)

(21) Appl. No.: 17/792,516

(22) PCT Filed: Jan. 31, 2020
(86) PCT No.: PCT/JP2020/003656

§ 371 Date: Jul. 13, 2022

(51) Int. Cl. B60W 30/165; B60W 30/12; B60W 40/105; B60W 40/114

(52) U.S. Cl. CPC B60W 30/165; B60W 30/12; B60W 40/105; B60W 40/114; B60W 2420/42; B60W 2420/52; B60W 2520/14; B60W 2552/53; B60W 2554/402; B60W 2554/4041; B60W 2554/802; B60W 2556/10; B60W 2556/20

(57) ABSTRACT

Provided is a preceding vehicle determining device including: a signal acquisition unit configured to acquire a signal from an object detection device; a border setting unit configured to set a border of a lane on which the own vehicle is traveling; a determination area setting unit configured to set a preceding vehicle determination area being an area forward of the own vehicle based on at least one piece of information out of vehicle type information, device type information, detection state information, or preceding vehicle information being information on a vehicle set as a preceding vehicle in previous processing, and based on the border set by the border setting unit; and a preceding vehicle determining unit configured to determine whether the another vehicle is to be set as the preceding vehicle based on a position of the another vehicle with respect to the preceding vehicle determination area.

### TECHNICAL FIELD

This disclosure relates to a preceding vehicle determining device and a preceding vehicle determining program.

### Background Art

Hitherto, there has been known following control which selects, from other vehicles traveling forward of an own vehicle, as a preceding vehicle, another vehicle traveling on the same lane as that of an own lane on which the own vehicle is traveling, and causes the own vehicle to travel while following the preceding vehicle. In the following control, it is desired to detect cut-in of another vehicle different from the preceding vehicle between the own vehicle and the preceding vehicle, or separation of the preceding vehicle from the own lane, to thereby appropriately select the preceding vehicle.

On a curved road, another vehicle traveling in an adjacent lane being a lane adjacent to the own lane is liable to be erroneously selected as a preceding vehicle. Accordingly, a related-art travel control device for a vehicle does not detect the cut-in of the another vehicle forward of the own vehicle or the separation of the preceding vehicle to another lane when the own vehicle is traveling on the curved road (for example, refer to Patent Literature 1).

### CITATION LIST

### Patent Literature

[PTL 1] JP 6363517 B2

### SUMMARY OF INVENTION

### Technical Problem

However, the device as disclosed in Patent Literature 1 may erroneously determine another vehicle traveling on the adjacent lane as a preceding vehicle even when the own vehicle is not traveling on a curved road. For example, when a distance between forward another vehicle traveling on the adjacent lane and the own vehicle is shorter than a distance between the preceding vehicle and the own vehicle, and the another vehicle is close to a border between the own lane and the adjacent lane, there is a fear in that the another vehicle may be determined as the preceding vehicle.

This disclosure has been made to solve the above-mentioned problem, and has an object to provide a preceding vehicle determining device and a preceding vehicle determining program which are capable of suppressing erroneous determination of a preceding vehicle.

### Solution to Problem

According to one embodiment of this disclosure, there is provided a preceding vehicle determining device including: a signal acquisition unit configured to acquire a signal from an object detection device configured to detect an object forward of an own vehicle; a border setting unit configured to set a border of a lane on which the own vehicle is traveling; a determination area setting unit configured to set a preceding vehicle determination area being an area forward of the own vehicle based on at least one piece of information out of vehicle type information being information on a type of another vehicle detected by the object detection device, device type information being information on a type of the object detection device, detection state information being information on a state of detection of the object by the object detection device, or preceding vehicle information being information on a vehicle set as a preceding vehicle in previous processing, and based on the border set by the border setting unit; and a preceding vehicle determining unit configured to determine whether the another vehicle is to be set as the preceding vehicle based on a position of the another vehicle with respect to the preceding vehicle determination area.

According to one embodiment of this disclosure, there is provided a preceding vehicle determining program for causing a computer to execute: signal acquisition processing of acquiring a signal from an object detection device configured to detect an object forward of an own vehicle; border setting processing of setting a border of a lane on which the own vehicle is traveling; determination area setting processing of setting a preceding vehicle determination area being an area forward of the own vehicle based on at least one piece of information out of vehicle type information being information on a type of another vehicle detected by the object detection device, device type information being information on a type of the object detection device, detection state information being information on a state of detection of the object by the object detection device, or preceding vehicle information being information on a vehicle set as a preceding vehicle in previous processing, and based on the border set in the border setting processing; and preceding vehicle determining processing of determining whether the another vehicle is to be set as the preceding vehicle based on a position of the another vehicle with respect to the preceding vehicle determination area.

### Advantageous Effects of Invention

According to the preceding vehicle determining device and the preceding vehicle determining program of this disclosure, it is possible to suppress erroneous determination of the preceding vehicle.

### BRIEF DESCRIPTION OF DRAWINGS

FIG. 1 is a block diagram for illustrating a preceding vehicle determining device according to a first embodiment of this disclosure.

FIG. 2 is a plan view for illustrating an example of borders of a lane, a preceding vehicle determination area, and margin distances.

FIG. 3 is a plan view for illustrating a state in which a two-wheeled vehicle is traveling near a center of an own lane.

FIG. 4 is a plan view for illustrating a state in which a two-wheeled vehicle is traveling adjacently to the border on a left side of the own lane.

FIG. 5 is a flowchart for illustrating a preceding vehicle determining routine executed by the preceding vehicle determining device of FIG. 1.

FIG. 6 is a block diagram for illustrating a preceding vehicle determining device according to a second embodiment of this disclosure.

FIG. 7 is a flowchart for illustrating a preceding vehicle determining routine executed by the preceding vehicle determining device of FIG. 6.

FIG. 8 is a block diagram for illustrating a preceding vehicle determining device according to a third embodiment of this disclosure.

FIG. 9 is a flowchart for illustrating a preceding vehicle determining routine executed by the preceding vehicle determining device of FIG. 8.

FIG. 10 is a flowchart for illustrating a preceding vehicle determining routine executed by a preceding vehicle determining device according to a fourth embodiment of this disclosure.

FIG. 11 is a flowchart for illustrating a preceding vehicle determining routine executed by a preceding vehicle determining device according to a fifth embodiment of this disclosure.

FIG. 12 is a plan view in a case in which a margin distance on a left side and a margin distance on a right side are different from each other.

FIG. 13 is a plan view in a case in which the left margin distance and the right margin distance take negative values.

FIG. 14 is a graph for showing a relationship between a relative distance and the margin distance.

FIG. 15 is a configuration diagram for illustrating a first example of a processing circuit which implements each of functions of the preceding vehicle determining devices according to the first embodiment to the fifth embodiment.

FIG. 16 is a configuration diagram for illustrating a second example of the processing circuit which implements each of the functions of the preceding vehicle determining devices according to the first embodiment to the fifth embodiment.

### DESCRIPTION OF EMBODIMENTS

Now, embodiments of this disclosure are described with reference to the drawings.

### First Embodiment

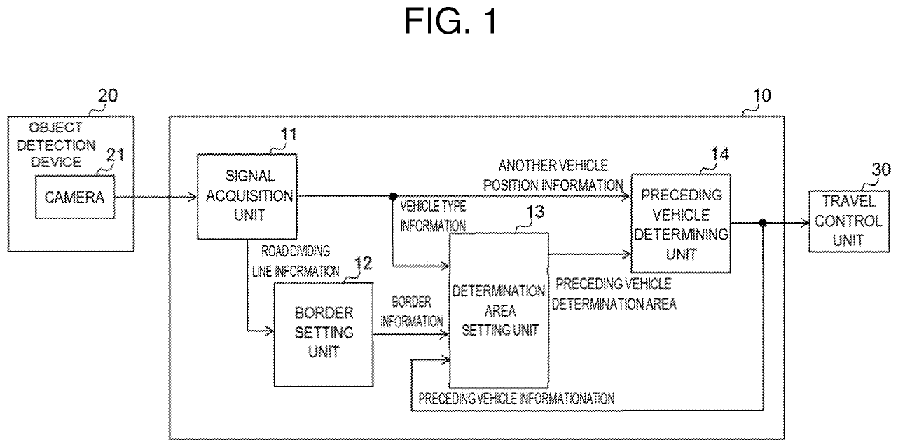

FIG. 1 is a block diagram for illustrating a preceding vehicle determining device according to a first embodiment of this disclosure. As illustrated in FIG. 1, a preceding vehicle determining device 10 includes, as functional blocks, a signal acquisition unit 11, a border setting unit 12, a determination area setting unit 13, and a preceding vehicle determining unit 14.

The signal acquisition unit 11 acquires a signal from an object detection device 20. The object detection device 20 includes a camera 21.

The camera 21 is provided, for example, between a room mirror and a windshield of an own vehicle. The camera 21 captures an image of a forward area of the own vehicle through the windshield. The camera 21 uses a well-known image recognition technology to detect objects, such as other vehicles, obstacles, and road dividing lines, existing forward of the own vehicle. The road dividing line is a line continuously or intermittently applied to a road surface, for example, a white line.

The camera 21 discriminates a type of the another vehicle based on a shape of the detected another vehicle. After that, the camera 21 transmits, to the signal acquisition unit 11, vehicle type information being information on the type of the detected another vehicle. The vehicle type information includes whether the another vehicle is a four-wheeled vehicle or a two-wheeled vehicle. For example, when a lateral width of the detected another vehicle is equal to or longer than a threshold value, the camera 21 discriminates the another vehicle as a four-wheeled vehicle. When a lateral width of the detected another vehicle is shorter than the threshold value, the camera 21 discriminates the another vehicle as a two-wheeled vehicle. Moreover, the camera 21 adds, for each another vehicle, identification information for identifying the another vehicle to the vehicle type information.

The border setting unit 12 sets borders of the own lane being a lane on which the own vehicle is traveling. More specifically, the border setting unit 12 first acquires a camera detection signal from the signal acquisition unit 11. The camera detection signal includes road dividing line information. After that, the border setting unit 12 sets the borders of the own lane based on the road dividing line information.

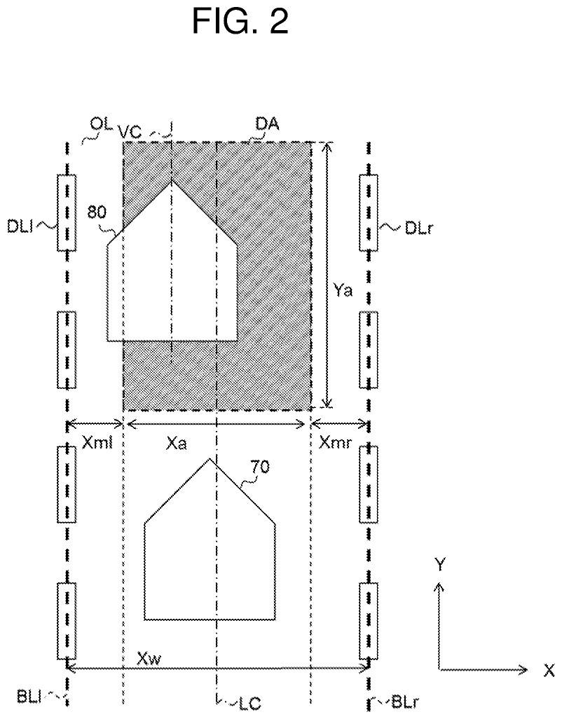

FIG. 2 is a plan view for illustrating borders of the own lane, margin distances, and a preceding vehicle determination area. In FIG. 2, a width direction of an own lane OL being a lane on which an own vehicle 70 is traveling is set as an X direction, and a direction parallel to the own lane OL is set as a Y direction. That is, the Y direction is a travel direction of each of the own vehicle 70 and an another vehicle 80.

As illustrated in FIG. 2, the border setting unit 12 sets a center in a left-and-right direction of a road dividing line DLl of the own lane OL on the left side as a border BLl on the left side of the own lane OL. Moreover, the border setting unit 12 sets a center in the left-and-right direction of a road dividing line DLr of the own lane OL on the right side as a border BLr on the right side of the own lane OL.

The determination area setting unit 13 sets a preceding vehicle determination area DA based on the vehicle type information, preceding vehicle information being information relating to the vehicle set as the preceding vehicle by the preceding vehicle determining unit 14 in previous processing, and the borders BLl and BLr.

The preceding vehicle determining unit 14 acquires the preceding vehicle determination area DA set by the determination area setting unit 13. The preceding vehicle determining unit 14 determines whether or not the another vehicle 80 is to be set as a preceding vehicle based on a position of the another vehicle 80 with respect to the preceding vehicle determination area DA.

As illustrated in FIG. 2, a center line VC of the another vehicle 80 in the width direction is positioned within the preceding vehicle determination area DA. In this case, the preceding vehicle determining unit 14 sets the another vehicle 80 as a preceding vehicle. Meanwhile, when the center line VC of the another vehicle 80 in the width direction is not positioned within the preceding vehicle determination area DA, the preceding vehicle determining unit 14 does not set the another vehicle 80 as a preceding vehicle. In other words, in this case, the preceding vehicle determining unit 14 determines that the another vehicle 80 is not a preceding vehicle.

When the preceding vehicle determining unit 14 sets the another vehicle 80 as a preceding vehicle, the preceding vehicle determining unit 14 transmits the preceding vehicle information to the determination area setting unit 13. The preceding vehicle information includes the identification information on the preceding vehicle.

When the identification information on the another vehicle 80 detected in current processing matches the identification information on the another vehicle 80 set as a preceding vehicle in the previous processing, the determination area setting unit 13 determines that the another vehicle 80 is a continuous preceding vehicle. That is, the continuous preceding vehicle is the another vehicle 80 continuously determined as a preceding vehicle.

That is, more specifically, the determination area setting unit 13 sets the preceding vehicle determination area DA based on the information on whether the another vehicle 80 is a four-wheeled vehicle or a two-wheeled vehicle, the information on whether or not the another vehicle 80 is a continuous preceding vehicle, and the borders BLl and BLr.

The preceding vehicle determining unit 14 transmits, to the travel control unit 30, information on whether or not a preceding vehicle exists, and information on another vehicle 80 set, when a preceding vehicle exists, as the preceding vehicle.

When a preceding vehicle exists, and execution of following control is allowed, the travel control unit 30 controls a driving device, a braking device, a steering device, and the like of the own vehicle to execute the following control. The following control is control which causes the own vehicle 70 to travel while following a preceding vehicle. The following control includes inter-vehicle distance control and preceding vehicle following control. The inter-vehicle distance control is control which maintains an inter-vehicle distance to a set distance through use of the driving device and the braking device. The inter-vehicle distance is a distance between the preceding vehicle and the own vehicle in the lane direction. The preceding vehicle following control is control which causes the own vehicle 70 to travel while following a travel trajectory of the preceding vehicle through use of the steering device.

A detailed description is now given of a setting method for the preceding vehicle determination area DA by the determination area setting unit 13. As illustrated in FIG. 2, the preceding vehicle determination area DA is a rectangular area forward of the own vehicle 70. The determination area setting unit 13 sets a length obtained by subtracting margin distances Xml and Xmr being distances in the X direction from a width Xw of the own lane OL as a lateral width Xa of the preceding vehicle determination area DA. A length Ya of the preceding vehicle determination area DA in the Y axis direction is set in advance in the determination area setting unit 13.

Description is now given of a reason for setting the preceding vehicle determination area DA based on whether the another vehicle 80 is a four-wheeled vehicle or a two-wheeled vehicle, and a specific method for the setting.

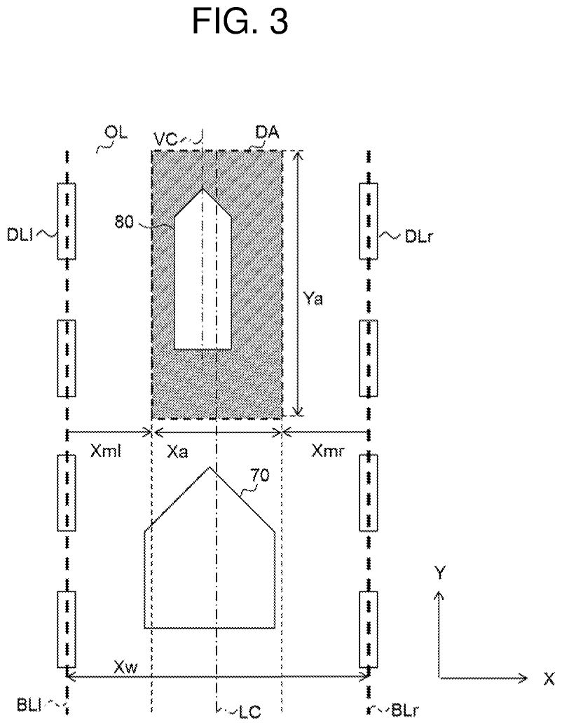

FIG. 3 is a plan view for illustrating a state in which a two-wheeled vehicle being another vehicle 80 is traveling near a center of the own lane OL. In this state, it is preferred that the own vehicle 70 travel while following the two-wheeled vehicle as in a case in which the another vehicle 80 is a four-wheeled vehicle.

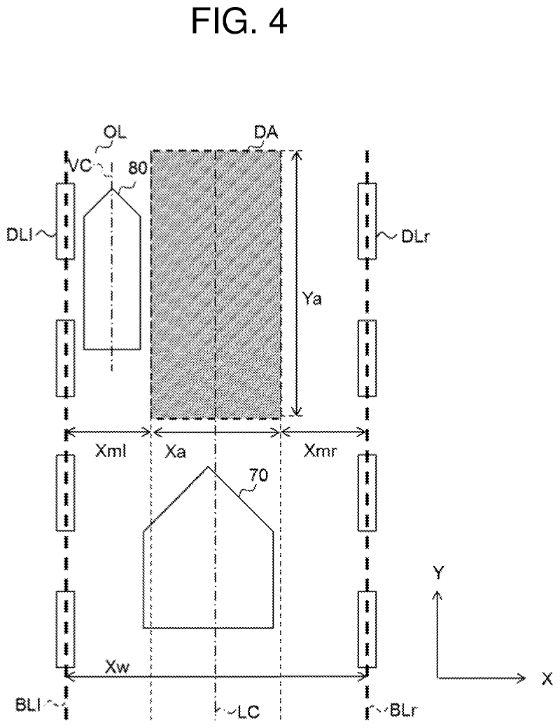

FIG. 4 is a plan view for illustrating a state in which a two-wheeled vehicle being another vehicle 80 is traveling near the border BLl of the own lane OL on the left side. In this state, it is often the case that the two-wheeled vehicle is traveling at a speed greatly different from those of the own vehicle 70 and vehicles around the two-wheeled vehicle.

For example, the two-wheeled vehicle traveling at a speed lower than the travel speeds of the vehicles around the two-wheeled vehicle is often traveling near the border BLl of the own lane OL on the left side. When the preceding vehicle determining device 10 sets such a two-wheeled vehicle as a preceding vehicle, the own vehicle 70 decelerates in order to follow this two-wheeled vehicle. Thus, in this case, it is desired that the own vehicle 70 not follow this two-wheeled vehicle, and pass this two-wheeled vehicle.

Moreover, a two-wheeled vehicle turning right at an intersection is often traveling near the border BLr of the own lane OL on the right side at a speed lower than travel speeds of the vehicles around the two-wheeled vehicle. When the preceding vehicle determining device 10 sets such a two-wheeled vehicle as a preceding vehicle, the own vehicle 70 decelerates in order to follow this two-wheeled vehicle. Thus, in this case, it is desired that the own vehicle 70 not follow this two-wheeled vehicle.

Accordingly, the determination area setting unit 13 sets the preceding vehicle determination area DA at the time when the type of the another vehicle 80 is a two-wheeled vehicle to be narrower in the width direction of the own lane OL than the preceding vehicle determination area DA at the time when the type of the another vehicle 80 is a four-wheeled vehicle. That is, the determination area setting unit 13 sets the lateral width Xa of the preceding vehicle determination area DA at the time when the type of the another vehicle 80 is the two-wheeled vehicle to a smaller value than the lateral width Xa of the preceding vehicle determination area DA at the time when the type of the another vehicle 80 is the four-wheeled vehicle.

In other words, the determination area setting unit 13 sets the margin distances Xml and Xmr at the time when the type of the detected another vehicle 80 is the two-wheeled vehicle to larger values than the margin distances Xml and Xmr at the time when the type of the detected another vehicle 80 is the four-wheeled vehicle.

As a result, a two-wheeled vehicle traveling near the border BLl or BLr of the own lane OL is less likely to be detected as a preceding vehicle. Thus, a case in which the own vehicle 70 travels while following a two-wheeled vehicle traveling near the border BLl or BLr of the own lane OL is suppressed.

Consequently, for example, when a travel speed of the two-wheeled vehicle traveling near the border BLl or BLr of the own lane OL is lower than the travel speed of the own vehicle 70, the own vehicle 70 can pass this two-wheeled vehicle. As described above, forward another vehicle is more appropriately set as a preceding vehicle.

Incidentally, in a case in which the following control is being executed, after another vehicle 80 is once set as a preceding vehicle, even when the another vehicle 80 travels at a position apart more or less from the center LC of the own lane OL, it is desired that this another vehicle be continuously set as the preceding vehicle.

Accordingly, the determination area setting unit 13 sets the preceding vehicle determination area DA at the time when the another vehicle 80 is a continuous preceding vehicle to be wider in the width direction of the own lane OL than the preceding vehicle determination area DA at the time when the another vehicle 80 is not a continuous preceding vehicle. The case in which the another vehicle 80 is not a continuous preceding vehicle is a case in which the identification information on the another vehicle 80 is different from the identification information on the preceding vehicle. The case in which the another vehicle 80 is the continuous preceding vehicle is a case in which the identification information on the another vehicle 80 matches the identification information on the preceding vehicle.

That is, the determination area setting unit 13 sets the lateral width Xa of the preceding vehicle determination area DA at the time when the another vehicle 80 is a continuous preceding vehicle to a larger value than the lateral width Xa of the preceding vehicle determination area DA at the time when the another vehicle 80 is not a continuous preceding vehicle. In other words, the determination area setting unit 13 sets the margin distances Xml and Xmr at the time when the detected another vehicle 80 is a continuous preceding vehicle to smaller values than the margin distances Xml and Xmr at the time when the detected another vehicle 80 is not a continuous preceding vehicle.

The determination area setting unit 13 sets the margin distances Xml and Xmr at the time when the another vehicle 80 is a continuous preceding vehicle and is also a four-wheeled vehicle to first margin distances Xml1 and Xmr1. The first margin distances Xml1 and Xmr1 are each, for example, 0.2 m. The lateral width Xa of the preceding vehicle determination area DA in this case is referred to as “first lateral width Xa1.”

Further, the determination area setting unit 13 sets the margin distances Xml and Xmr at the time when the another vehicle 80 is a continuous preceding vehicle and is also a two-wheeled vehicle to second margin distances Xml2 and Xmr2 longer than the first margin distances Xml1 and Xmr1, respectively. The second margin distances Xml2 and Xmr2 are each, for example, 0.5 m. The lateral width Xa of the preceding vehicle determination area DA in this case is referred to as “second lateral width Xa2.” As a result, the second lateral width Xa2 is set to a value smaller than the first lateral width Xa1.

Still further, the determination area setting unit 13 sets the margin distances Xml and Xmr at the time when the another vehicle 80 is not a continuous preceding vehicle and is a four-wheeled vehicle to third margin distances Xml3 and Xmr3 longer than the first margin distances Xml1 and Xmr1, respectively. The third margin distances Xml3 and Xmr3 are each, for example, 0.5 m. The lateral width Xa of the preceding vehicle determination area DA in this case is referred to as “third lateral width Xa3.” As a result, the third lateral width Xa3 is set to a value smaller than the first lateral width Xa1.

Yet further, the determination area setting unit 13 sets the margin distances Xml and Xmr at the time when the another vehicle 80 is not a continuous preceding vehicle and is a two-wheeled vehicle to fourth margin distances Xml4 and Xmr4 longer than the second margin distances Xml2 and Xmr2 and longer than the third margin distances Xml3 and Xmr3, respectively. The fourth margin distances Xml4 and Xmr4 are each, for example, 1 m. The lateral width Xa of the preceding vehicle determination area DA in this case is referred to as “fourth lateral width Xa4.” As a result, the fourth lateral width Xa4 is set to a value shorter than the second lateral width Xa2 and shorter than the third lateral width Xa3.

For example, when the width Xw of the detected own lane OL is 3.5 m, the first lateral width Xa1 is set to 3.1 m, the second lateral width Xa2 is set to 2.5 m, the third lateral width Xa3 is set to 2.5 m, and the fourth lateral width Xa4 is set to 1.5 m. The numerical values of the margin distances Xml and Xmr and the lateral width Xa are simply examples, and the distances and the width are not limited to those numerical values.

As described above, the determination area setting unit 13 changes the margin distances Xml and Xmr based on the vehicle type information on the another vehicle 80, to thereby set the preceding vehicle determination area DA.

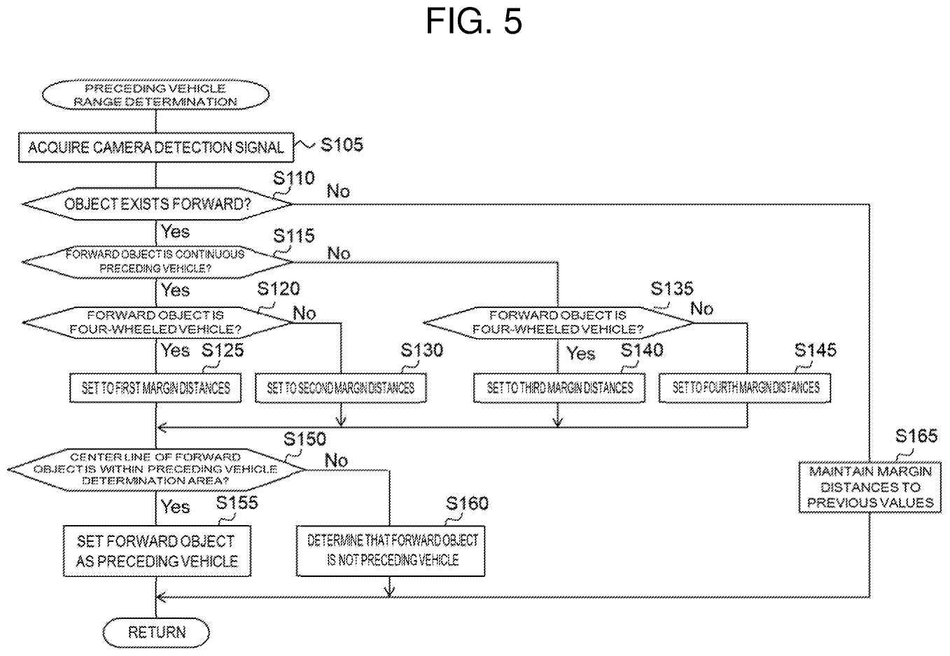

FIG. 5 is a flowchart for illustrating a preceding vehicle determining routine executed by the preceding vehicle determining device 10 according to the first embodiment. The routine of FIG. 5 is started when, for example, the preceding vehicle determining device 10 is activated, and is executed each time a predetermined period elapses.

When the preceding vehicle determining device 10 starts the routine of FIG. 5, in Step S105, the preceding vehicle determining device 10 first acquires the camera detection signal from the camera 21. After that, in Step S110, the preceding vehicle determining device 10 determines whether or not an object exists forward of the own vehicle.

When an object exists forward of the own vehicle, in Step S115, the preceding vehicle determining device 10 determines whether or not the forward object is a continuous preceding vehicle.

When the forward object is a continuous preceding vehicle, in Step S120, the preceding vehicle determining device 10 determines whether or not the forward object is a four-wheeled vehicle. When the forward object is a four-wheeled vehicle, in Step S125, the preceding vehicle determining device 10 sets the margin distances Xml and Xmr to the first margin distances Xml1 and Xmr1, respectively. When the forward object is not a four-wheeled vehicle, the forward object is considered to be a two-wheeled vehicle, and thus the preceding vehicle determining device 10 sets, in Step S130, the margin distances Xml and Xmr to the second margin distances Xml2 and Xmr2, respectively.

When the forward object is not a continuous preceding vehicle, in Step S135, the preceding vehicle determining device 10 determines whether or not the forward object is a four-wheeled vehicle. When the forward object is a four-wheeled vehicle, in Step S140, the preceding vehicle determining device 10 sets the margin distances Xml and Xmr to the third margin distances Xml3 and Xmr3, respectively. When the forward object is not a four-wheeled vehicle, in Step S145, the preceding vehicle determining device 10 sets the margin distances Xml and Xmr to the fourth margin distances Xml4 and Xmr4, respectively.

After that, in Step S150, the preceding vehicle determining device 10 determines whether or not the center line VC of the forward object is positioned within the preceding vehicle determination area DA. When the center line VC of the forward object is positioned within the preceding vehicle determination area DA, in Step S155, the preceding vehicle determining device 10 sets the forward object as a preceding vehicle, and temporarily finishes this routine. Meanwhile, when the center line VC of the forward object is not positioned within the preceding vehicle determination area DA, in Step S160, the preceding vehicle determining device 10 determines that the forward object is not a preceding vehicle, and temporarily finishes this routine.

When an object does not exist forward of the own vehicle, in Step S165, the preceding vehicle determining device 10 maintains the margin distances Xml and Xmr to previous values, and temporality finishes this routine. Moreover, control for avoiding collision may independently be executed by another system (not shown) of the own vehicle.

As described above, a preceding vehicle determining method according to the first embodiment includes a signal acquisition step, a border setting step, a determination area setting step, and a preceding vehicle determining step. The signal acquisition step is a step of acquiring the camera detection signal from the camera 21 for detecting an object forward of the own vehicle 70. The border setting step is a step of setting the borders BLl and BLr of the own lane OL. The determination area setting step is a step of setting the preceding vehicle determination area DA based on the vehicle type information detected by the camera 21, the preceding vehicle information transmitted from the preceding vehicle determining unit 14, and the borders BLl and BLr set in the border setting step. The preceding vehicle determining step is a step of determining whether or not the another vehicle 80 is to be set as a preceding vehicle based on the position of the another vehicle 80 with respect to the preceding vehicle determination area DA.

Moreover, a preceding vehicle determining program according to the first embodiment is a program for causing a computer to execute the above-mentioned preceding vehicle determining method.

That is, the preceding vehicle determining program is a program for causing a computer to execute signal acquisition processing, border setting processing, determination area setting processing, and preceding vehicle determining processing. The signal acquisition processing is processing of acquiring the camera detection signal from the camera 21 for detecting an object forward of the own vehicle 70. The border setting processing is processing of setting the borders BLl and BLr of the own lane OL. The determination area setting processing is processing of setting the preceding vehicle determination area DA based on the vehicle type information detected by the camera 21, the preceding vehicle information transmitted from the preceding vehicle determining unit 14, and the borders BLl and BLr set in the border setting processing. The preceding vehicle determining processing is processing of determining whether or not the another vehicle 80 is to be set as a preceding vehicle based on the position of the another vehicle 80 with respect to the preceding vehicle determination area DA.

As described above, according to the preceding vehicle determining device 10 and the preceding vehicle determining program of the first embodiment, the preceding vehicle determination area DA is set based on the vehicle type information based on the camera detection signal acquired from the camera 21, the preceding vehicle information transmitted from the preceding vehicle determining unit 14, and the borders BLl and BLr. After that, when another vehicle exists in the preceding vehicle determination area DA, the another vehicle is set as a preceding vehicle. As a result, even when another vehicle traveling on the adjacent lane approaches the border between the own lane and the adjacent lane, the another vehicle is outside the preceding vehicle determination area DA, and thus a case in which the another vehicle traveling on the adjacent lane is set as a preceding vehicle is suppressed. Consequently, erroneous determination of the preceding vehicle is suppressed.

Moreover, the determination area setting unit 13 sets the length obtained by subtracting the margin distances Xml and Xmr from the width Xw of the own lane OL as the lateral width Xa of the preceding vehicle determination area DA. After that, the determination area setting unit 13 changes the margin distances Xml and Xmr based on the vehicle type information and the preceding vehicle information, to thereby set the preceding vehicle determination area DA. As a result, the preceding vehicle determination area DA is set while the borders of the own lane are considered as references, and thus, even when another vehicle traveling on the adjacent lane approaches the border between the own lane and the adjacent lane, the case in which the another vehicle traveling on the adjacent lane is set as a preceding vehicle is more suppressed. Consequently, the erroneous determination of the preceding vehicle is more suppressed.

Moreover, the determination area setting unit 13 sets the preceding vehicle determination area DA at the time when the another vehicle is a continuous preceding vehicle to be wider than the preceding vehicle determination area DA at the time when the another vehicle is not a continuous preceding vehicle. Thus, the preceding vehicle determining device 10 can stably continue to select the continuous preceding vehicle. As a result, a case in which the preceding vehicle is missed, and consequently, the own vehicle accelerates or the own vehicle approaches too close to the preceding vehicle is suppressed.

Moreover, the determination area setting unit 13 sets the preceding vehicle determination area DA at the time when the type of the another vehicle is the two-wheeled vehicle to be narrower in the width direction of the own lane OL than the preceding vehicle determination area DA at the time when the type of the another vehicle is the four-wheeled vehicle. Thus, a two-wheeled vehicle traveling near the center of the own lane OL is set as a preceding vehicle, and a two-wheeled vehicle traveling near the border of the own lane OL is determined not to be a preceding vehicle. As a result, a forward another vehicle is more appropriately be set as a preceding vehicle. Consequently, for example, a case in which a two-wheeled vehicle traveling at low speed near the border of the own lane OL is set as a preceding vehicle, and the own vehicle is accordingly decelerated is suppressed.

In the first embodiment, the preceding vehicle determining unit 14 determines whether or not another vehicle 80 is a continuous preceding vehicle based on the identification information on the another vehicle 80, but the method of determining whether or not another vehicle 80 is a continuous preceding vehicle is not limited to this method. For example, the preceding vehicle determining unit 14 may determine whether or not another vehicle 80 is a continuous preceding vehicle based on a difference between a position of another vehicle 80 set as a preceding vehicle in the current processing and a position of another vehicle 80 set as a preceding vehicle in the previous processing. In this case, the camera 21 is not required to add the identification information to the vehicle type information.

Moreover, the preceding vehicle determining unit 14 may determine whether or not another vehicle 80 is a continuous preceding vehicle based on the identification information on the another vehicle 80 and the position of the another vehicle 80, or may determine whether or not another vehicle 80 is a continuous preceding vehicle based on vehicle information transmitted around the another vehicle 80 by the another vehicle 80.

### Second Embodiment

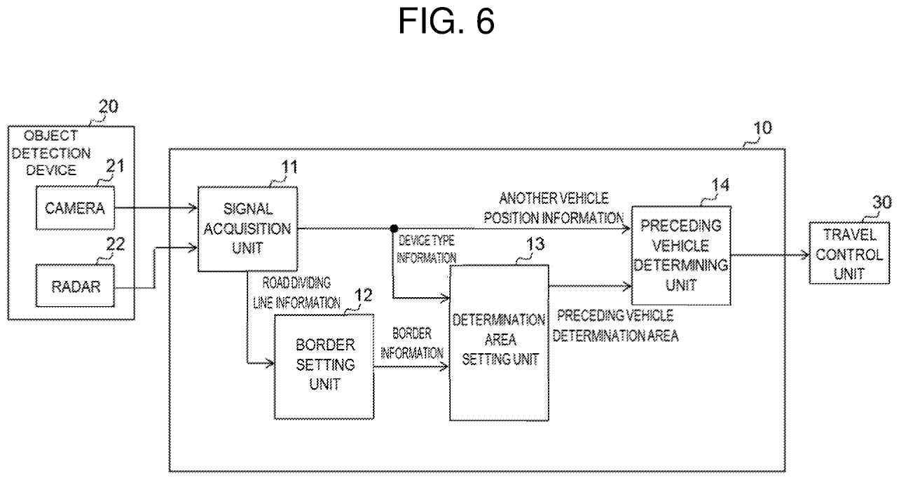

Description is now given of a preceding vehicle determining device 10 according to a second embodiment of this disclosure. FIG. 6 is a block diagram for illustrating the preceding vehicle determining device 10 according to the second embodiment. As illustrated in FIG. 6, the object detection device 20 includes the camera 21 and a radar 22.

The radar 22 is provided in a center portion at a front end of the own vehicle, for example, inside a front grill. The radar 22 emits an electromagnetic wave forward of the own vehicle, and receives a reflected wave reflected by an object forward of the own vehicle, to thereby detect the object forward of the own vehicle.

A configuration other than the object detection device 20 including the radar 22 is the same as that in the first embodiment.

The signal acquisition unit 11 acquires the camera detection signal from the camera 21 and a radar detection signal from the radar 22. The determination area setting unit 13 unifies information on the object detected by the camera 21 and information on the object detected by the radar 22. As a result, even when one of the camera 21 or the radar 22 cannot detect an object, such as another vehicle or an obstacle, as long as another thereof detects the object, the preceding vehicle determining device 10 can continuously recognize the existence of the object.

Moreover, the determination area setting unit 13 appropriately sets the preceding vehicle determination area DA based on advantages and disadvantages of each of the camera 21 and the radar 22. For example, a detection accuracy for a position of an object by the radar 22 in the width direction of the lane is lower than a detection accuracy for the position of the object by the camera 21 in the width direction of the lane. Meanwhile, a detection accuracy for the position of the object by the radar 22 in a direction parallel to the lane, that is, a depth direction, is higher than a detection accuracy for the position of the object by the camera 21 in the depth direction.

Accordingly, the determination area setting unit 13 sets the preceding vehicle determination area DA based on device type information and the borders. The device type information is information relating to the type of the object detection device 20. In this case, the device type information is information to be used to distinguish a state in which an object forward of the own vehicle 70 is detected by at least the camera 21 and a state in which the object is detected by only the radar 22 from each other. More specifically, the determination area setting unit 13 sets the preceding vehicle determination area DA at the time when another vehicle 80 is detected by only the radar 22 to be narrower in the width direction of the own lane OL than the preceding vehicle determination area DA at the time when another vehicle 80 is detected by at least the camera 21.

That is, the determination area setting unit 13 sets the lateral width Xa of the preceding vehicle determination area DA at the time when another vehicle 80 is detected by only the radar 22 to be shorter than the lateral width Xa of the preceding vehicle determination area DA at the time when another vehicle 80 is detected by at least the camera 21. In other words, the determination area setting unit 13 sets the margin distances Xml and Xmr at the time when another vehicle 80 is detected by only the radar 22 to be larger values than the margin distances Xml and Xmr at the time when another vehicle 80 is detected by at least the camera 21.

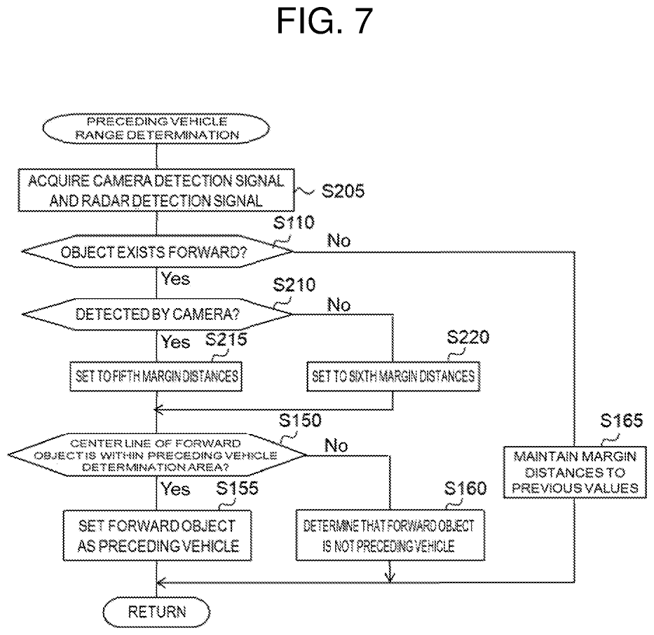

FIG. 7 is a flowchart for illustrating a preceding vehicle determining routine executed by the preceding vehicle determining device 10 according to the second embodiment. In FIG. 7, the same steps as those of FIG. 5 are denoted by the same reference symbols. The routine of FIG. 7 is started when the preceding vehicle determining device 10 is activated, and is executed each time a predetermined period elapses.

When the preceding vehicle determining device 10 starts the routine of FIG. 7, in Step S205, the preceding vehicle determining device 10 first acquires the camera detection signal from the camera 21 and the radar detection signal from the radar 22. After that, in Step S110, the preceding vehicle determining device 10 determines whether or not an object exists forward of the own vehicle.

When an object exists forward of the own vehicle, in Step S210, the preceding vehicle determining device 10 determines whether or not the forward object is detected by the camera 21.

When the forward object is detected by the camera 21, in Step S215, the preceding vehicle determining device 10 sets the margin distances Xml and Xmr to fifth margin distances Xml5 and Xmr5, respectively. The fifth margin distances Xml5 and Xmr5 are each, for example, 0.2 m. The lateral width Xa of the preceding vehicle determination area DA in this case is referred to as “fifth lateral width Xa5.” In this state, the case in which the forward object is detected by the camera 21 includes not only the case in which the forward object is detected by only the camera 21, but also the case in which the forward object is detected by both of the camera 21 and the radar 22.

When the forward object is not detected by the camera 21, that is, when the forward object is detected by only the radar 22, in Step S220, the preceding vehicle determining device 10 sets the margin distances Xml and Xmr to sixth margin distances Xml6 and Xmr6 longer than the fifth margin distances Xml5 and Xmr5, respectively. The six margin distances Xml6 and Xmr6 are each, for example, 1.0 m. The lateral width Xa of the preceding vehicle determination area DA in this case is referred to as “sixth lateral width Xa6.” As a result, the sixth lateral width Xa6 is set to a value smaller than the fifth lateral width Xa5.

As described above, the determination area setting unit 13 of the preceding vehicle determining device 10 according to the second embodiment sets the preceding vehicle determination area DA at the time when another vehicle is detected by only the radar 22 to be narrower in the width direction of the own lane than the preceding vehicle determination area DA at the time when another vehicle is detected by at least the camera 21. As a result, even when another vehicle is detected by only the radar 22, the case in which another vehicle traveling on the adjacent lane is set as a preceding vehicle is suppressed. Consequently, erroneous determination of the preceding vehicle by the radar 22 is suppressed.

The determination of whether or not an object is a continuous preceding vehicle, which is executed in the first embodiment, may be additionally executed by the preceding vehicle determining device 10 according to the second embodiment. When the determination of whether or not the object is a continuous preceding vehicle is to be added, it is only required to add a step of determining whether or not the object is a continuous preceding vehicle, for example, immediately before Step S210 of FIG. 7. After that, it is only required to determine whether or not the object is detected by the camera in each of the case in which the object is a continuous preceding vehicle and the case in which the object is not a continuous preceding vehicle.

### Third Embodiment

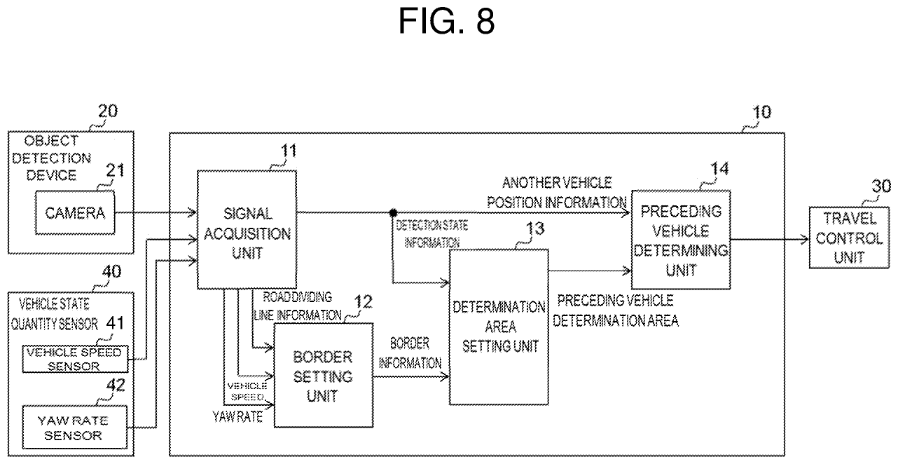

Description is now given of a preceding vehicle determining device 10 according to a third embodiment of this disclosure. FIG. 8 is a block diagram for illustrating the preceding vehicle determining device 10 according to the third embodiment. As illustrated in FIG. 8, the signal acquisition unit 11 acquires a vehicle state quantity from a vehicle state quantity sensor 40.

The vehicle state quantity sensor 40 includes a vehicle speed sensor 41 and a yaw rate sensor 42. The vehicle speed sensor 41 detects a vehicle speed being a travel speed of the own vehicle based on a rotation speed of each wheel of the own vehicle. The yaw rate sensor 42 detects a yaw rate of the own vehicle.

The configuration of the preceding vehicle determining device 10 other than the signal acquisition unit 11 being connected to the vehicle state quantity sensor 40 is the same as that in the first embodiment.

The signal acquisition unit 11 acquires the camera detection signal from the camera 21, a signal including vehicle speed information from the vehicle speed sensor 41, and a signal including yaw rate information from the yaw rate sensor 42.

When the road dividing lines DLl and DLr are not detected by the camera 21, the border setting unit 12 estimates the borders of the own lane based on the vehicle speed and the yaw rate. More specifically, the border setting unit 12 calculates a rotation curvature of the own vehicle based on the vehicle speed and the yaw rate. After that, the border setting unit 12 regards the rotation curvature of the own vehicle as a curvature of the own lane. This curvature is hereinafter referred to as “estimated curvature,” and is given by Expression (1).

(Estimated curvature)=(Yaw rate)/(Vehicle speed) (1)

The border setting unit 12 estimates the borders of the own lane based on the estimated curvature and the lateral width of the own lane. In this case, to the lateral width of the own lane, for example, a standard lane width of 3.5 m is applied.

However, the detected yaw rate of the own vehicle tends to change as the time elapses due to a steering wheel operation by a driver of the own vehicle. Thus, a shape and a position of the estimated borders of the lane are also likely to change as the time elapses.

Accordingly, the determination area setting unit 13 sets the preceding vehicle determination area DA based on detection state information and the borders set by the border setting unit 12. In the third embodiment, the detection state information is information on a state of detection of the road dividing lines by the camera 21. In other words, the detection state information is information to be used to distinguish a state in which the road dividing lines are detected by the camera 21 and a state in which the road dividing lines are not detected by the camera 21 from each other. More specifically, the determination area setting unit 13 sets the preceding vehicle determination area DA at the time when the road dividing lines DLl and DLr are not detected by the camera 21 to be narrower in the width direction of the lane than the preceding vehicle determination area DA at the time when the road dividing lines DLl and DLr are detected by the camera 21.

That is, the determination area setting unit 13 sets the lateral width Xa of the preceding vehicle determination area DA at the time when the road dividing lines DLl and DLr are not detected by the camera 21 to smaller values than the lateral width Xa of the preceding vehicle determination area DA at the time when the road dividing lines DLl and DLr are detected by the camera 21. In other words, the determination area setting unit 13 sets the margin distances Xml and Xmr at the time when the road dividing lines DLl and DLr are not detected by the camera 21 to larger values than the margin distances Xml and Xmr at the time when the road dividing lines DLl and DLr are detected by the camera 21.

As a result, when the road dividing lines DLl and DLr of the own lane are not detected by the camera 21, that is, the borders of the own lane are to be estimated, erroneous detection of the preceding vehicle is suppressed.

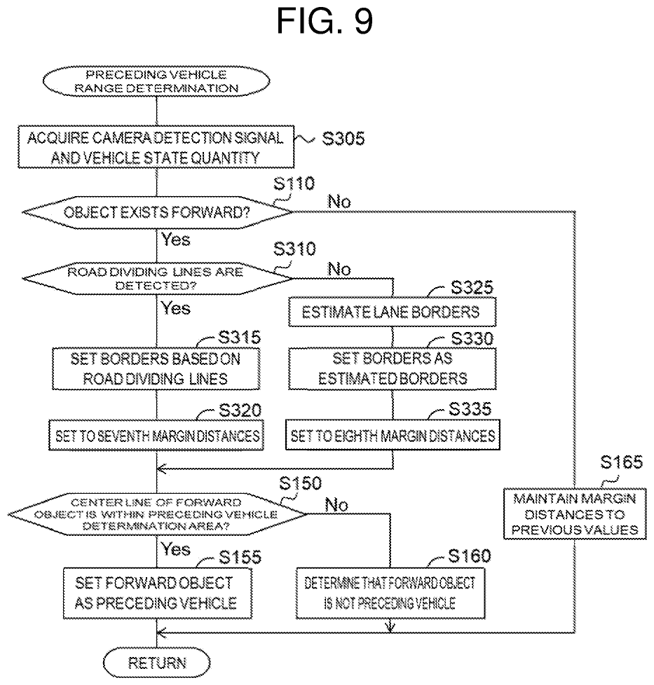

FIG. 9 is a flowchart for illustrating a preceding vehicle determining routine executed by the preceding vehicle determining device 10 according to the third embodiment. In FIG. 9, the same steps as those of FIG. 5 are denoted by the same reference symbols. The routine of FIG. 9 is started when the preceding vehicle determining device 10 is activated, and is executed each time a predetermined period elapses.

When the preceding vehicle determining device 10 starts the routine of FIG. 9, in Step S305, the preceding vehicle determining device 10 first acquires the camera detection signal from the camera 21 and a signal including the vehicle state quantity from the vehicle state quantity sensor 40. After that, in Step S110, the preceding vehicle determining device 10 determines whether or not an object exists forward of the own vehicle.

When an object exists forward of the own vehicle, in Step S310, the preceding vehicle determining device 10 determines whether or not the road dividing lines are detected.

When the road dividing lines are detected, in Step S315, the preceding vehicle determining device 10 sets the borders of the own lane based on the detected road dividing lines. After that, in Step S320, the preceding vehicle determining device 10 sets the margin distances Xml and Xmr to seventh margin distances Xml7 and Xmr7, respectively. The seventh margin distances Xml7 and Xmr7 are each, for example, 0.2 m. The lateral width Xa of the preceding vehicle determination area DA in this case is referred to as “seventh lateral width Xa7.”

When the road dividing lines are not detected, in Step S325, the preceding vehicle determining device 10 estimates the borders of the own lane based on the vehicle state quantity of the own vehicle. After that, in Step S330, the preceding vehicle determining device 10 sets the estimated borders as the borders of the own lane.

After that, in Step S335, the preceding vehicle determining device 10 sets the margin distances Xml and Xmr to eighth margin distances Xml8 and Xmr8 longer than the seventh margin distances Xml7 and Xmr7, respectively. The eighth margin distances Xml8 and Xmr8 are each, for example, 1.0 m. The lateral width Xa of the preceding vehicle determination area DA in this case is referred to as “eighth lateral width Xa8.” As a result, the eighth lateral width Xa8 is set to a value smaller than the seventh lateral width Xa7.

As described above, according to the preceding vehicle determining device 10 of the third embodiment, when the road dividing lines are not detected by the camera 21, the border setting unit 12 estimates the borders based on the travel speed and the yaw rate of the own vehicle. The determination area setting unit 13 sets the preceding vehicle determination area DA at the time when the road dividing lines DLl and DLr are not detected to be narrower in the width direction of the lane than the preceding vehicle determination area DA at the time when the road dividing lines DLl and DLr are detected. Consequently, erroneous determination of the preceding vehicle at the time when the lane is estimated is suppressed.

The determination of whether the object is a four-wheeled vehicle or a two-wheeled vehicle, which is executed in the first embodiment, may be additionally executed by the preceding vehicle determining device 10 according to the third embodiment. When the determination of whether or not the object is a four-wheeled vehicle or a two-wheeled vehicle is to be added, it is only required to add a step of determining whether or not the object is a four-wheeled vehicle, for example, immediately after Step S315 of FIG. 9 and immediately after Step S330 of FIG. 9. After that, it is only required to set the margin distances Xml and Xmr in each of the case in which the object is a four-wheeled vehicle and the case in which the object is a two-wheeled vehicle.

Moreover, in the preceding vehicle determining device 10 according to the third embodiment, as in the second embodiment, the signal acquisition unit 11 may acquire the signals from the object detection device 20 including the camera 21 and the radar 22. Moreover, the determination area setting unit 13 may set the preceding vehicle determination area DA at the time when another vehicle is detected by only the radar 22 to be narrower in the width direction of the own lane than the preceding vehicle determination area DA at the time when another vehicle is detected by at least the camera 21.

### Fourth Embodiment

Description is now given of a preceding vehicle determining device 10 according to a fourth embodiment of this disclosure. The configuration of the preceding vehicle determining device 10 according to the fourth embodiment is the same as that in the third embodiment.

In the preceding vehicle determining device 10 according to the fourth embodiment, the border setting unit 12 estimates the borders based on the travel speed and the yaw rate of the own vehicle when the road dividing lines DLl and DLr are not detected by the camera 21. However, in a case in which another vehicle is continuously determined as a preceding vehicle by the preceding vehicle determining unit 14, the determination area setting unit 13 sets the preceding vehicle determination area DA at the time when the road dividing lines DLl and DLr are not detected by the camera 21 to be wider in the width direction of the own lane than the preceding vehicle determination area DA at the time when the road dividing lines DLl and DLr are detected by the camera 21.

That is, in the case in which another vehicle is continuously determined as a preceding vehicle by the preceding vehicle determining unit 14, the determination area setting unit 13 sets the lateral width Xa of the preceding vehicle determination area DA at the time when the road dividing lines DLl and DLr are not detected by the camera 21 to a larger value than the lateral width Xa of the preceding vehicle determination area DA at the time when the road dividing lines DLl and DLr are detected by the camera 21. In other words, in the case in which another vehicle is continuously determined as a preceding vehicle by the preceding vehicle determining unit 14, the determination area setting unit 13 sets the margin distances Xml and Xmr at the time when the road dividing lines DLl and DLr are not detected by the camera 21 to smaller values than the margin distances Xml and Xmr at the time when the road dividing lines DLl and DLr are detected by the camera 21.

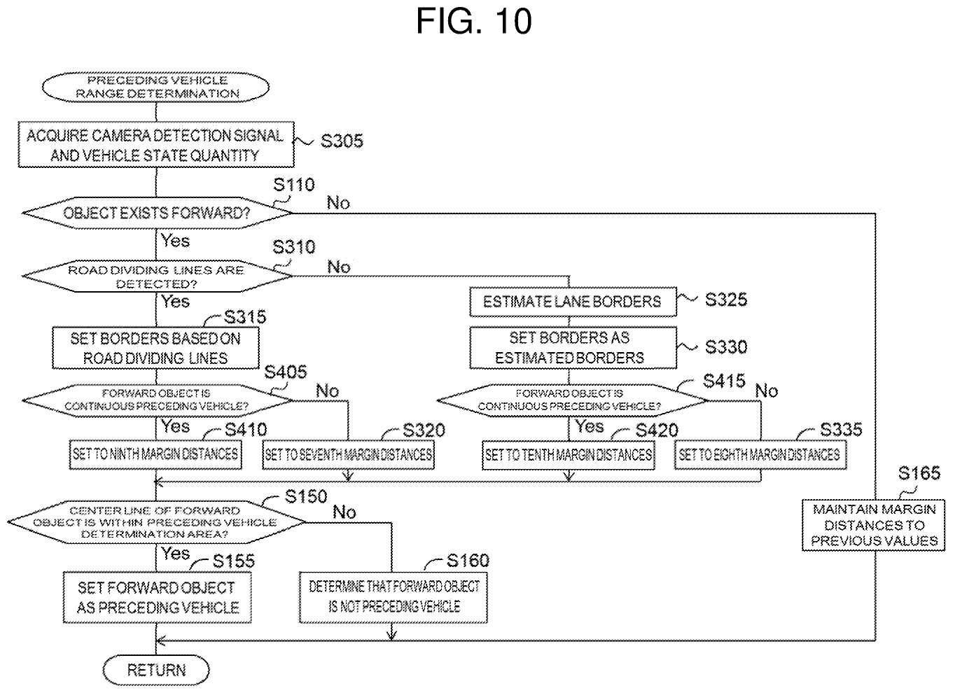

FIG. 10 is a flowchart for illustrating a preceding vehicle determining routine executed by the preceding vehicle determining device 10 according to the fourth embodiment. In FIG. 10, the same steps as those of FIG. 9 are denoted by the same reference symbols. The routine of FIG. 10 is started when the preceding vehicle determining device 10 is activated, and is executed each time a predetermined period elapses.

When the preceding vehicle determining device 10 determines that the road dividing lines are detected in Step S310, in Step S315, the preceding vehicle determining device 10 sets the borders based on the road dividing lines. After that, in Step S405, the preceding vehicle determining device 10 determines whether or not the forward object is a continuous preceding vehicle. When the forward object is not a continuous preceding vehicle, in Step S320, the preceding vehicle determining device 10 sets the margin distances Xml and Xmr to the seventh margin distances Xml7 and Xmr7, respectively. The seventh margin distances Xml7 and Xmr7 are each, for example, 0.5 m.

Meanwhile, when the forward object is a continuous preceding vehicle, in Step S410, the preceding vehicle determining device 10 sets the margin distances Xml and Xmr to ninth margin distances Xml9 and Xmr9 shorter than the seventh margin distances Xml7 and Xmr7, respectively. The ninth margin distances Xml9 and Xmr9 are each, for example, 0.2 m. The lateral width Xa of the preceding vehicle determination area DA in this case is referred to as “ninth lateral width Xa9.” As a result, the ninth lateral width Xa9 is set to a value larger than the seventh lateral width Xa7.

When the preceding vehicle determining device 10 determines that the road dividing lines are not detected in Step S310, the preceding vehicle determining device 10 estimates borders of the lane in Step S325, and sets the borders of the own lane as the estimated borders in Step S330. After that, in Step S415, the preceding vehicle determining device 10 determines whether or not the forward object is a continuous preceding vehicle.

When the forward object is not a continuous preceding vehicle, in Step S335, the preceding vehicle determining device 10 sets the margin distances Xml and Xmr to the eighth margin distances Xml8 and Xmr8, respectively. The eighth margin distances Xml8 and Xmr8 are each, for example, 1.0 m. As described above, the eighth margin distances Xml8 and Xmr8 are set to values larger than the seventh margin distances Xml7 and Xmr7.

Meanwhile, when the forward object is a continuous preceding vehicle, in Step S420, the preceding vehicle determining device 10 sets the margin distances Xml and Xmr to tenth margin distances Xml10 and Xmr10 shorter than the ninth margin distances Xml9 and Xmr9, respectively. The tenth margin distances Xml10 and Xmr10 are each, for example, 0.1 m. The lateral width Xa of the preceding vehicle determination area DA in this case is referred to as “tenth lateral width Xa10.” As a result, the tenth lateral width Xa10 is set to a value larger than the ninth lateral width Xa9.

As described above, the yaw rate of the own vehicle is likely to change temporally, and thus an error is liable to occur between the estimated border and an actual border. Thus, when the preceding vehicle determination area DA is set based on the estimated borders, the continuous preceding vehicle is more liable to be lost as compared to the case in which the preceding vehicle determination area DA is set based on the actual borders.

However, according to the preceding vehicle determining device 10 of the fourth embodiment, the preceding vehicle determination area DA based on the estimated borders at the time when the road dividing lines DLl and DLr are not detected by the camera 21 is set to be wider in the width direction of the lane than the preceding vehicle determination area DA at the time when the road dividing lines DLl and DLr are detected. As a result, the loss of the continuous preceding vehicle by the preceding vehicle determining device 10 is suppressed.

The determination of whether the object is a four-wheeled vehicle or a two-wheeled vehicle, which is executed in the first embodiment, may be additionally executed by the preceding vehicle determining device 10 according to the fourth embodiment. When the determination of whether or not the object is a four-wheeled vehicle or a two-wheeled vehicle is to be added, it is only required to add a step of determining whether or not the object is a four-wheeled vehicle, for example, as the subsequent step of the determination of Step S405 of FIG. 10 and the determination of Step S415 of FIG. 10. After that, it is only required to set the margin distances Xml and Xmr in each of the case in which the object is a four-wheeled vehicle and the case in which the object is a two-wheeled vehicle.

Moreover, in the preceding vehicle determining device 10 according to the fourth embodiment, as in the second embodiment, the signal acquisition unit 11 may acquire the signals from the object detection device 20 including the camera 21 and the radar 22. Moreover, the determination area setting unit 13 may set the preceding vehicle determination area DA at the time when another vehicle is detected by only the radar 22 to be narrower in the width direction of the own lane than the preceding vehicle determination area DA at the time when another vehicle is detected by at least the camera 21.

### Fifth Embodiment

Description is now given of a preceding vehicle determining device 10 according to a fifth embodiment of this disclosure. The configuration of the preceding vehicle determining device 10 according to the fifth embodiment is the same as that in the first embodiment. However, the information input to the determination area setting unit 13 is switched from the vehicle type information of FIG. 1 to information on a detection accuracy. Moreover, the determination area setting unit 13 calculates a detection reliability of an object based on the acquired information on the detection accuracy. The detection reliability is a degree of a probability of the detected position and shape of the object. The information on the detection reliability can be considered as information on a state of detection of the object by the object detection device 20, that is, detection state information.

The determination area setting unit 13 sets the preceding vehicle determination area DA based on the detection reliability of the object and the borders. More specifically, the determination area setting unit 13 calculates the detection reliability of the object, and increases the preceding vehicle determination area DA in the width direction of the own lane OL as the detection reliability increases.

That is, the determination area setting unit 13 sets the lateral width Xa of the preceding vehicle determination area DA to a larger value as the detection reliability of the object increases. In other words, the determination area setting unit 13 sets the margin distances Xml and Xmr to smaller values as the detection reliability increases.

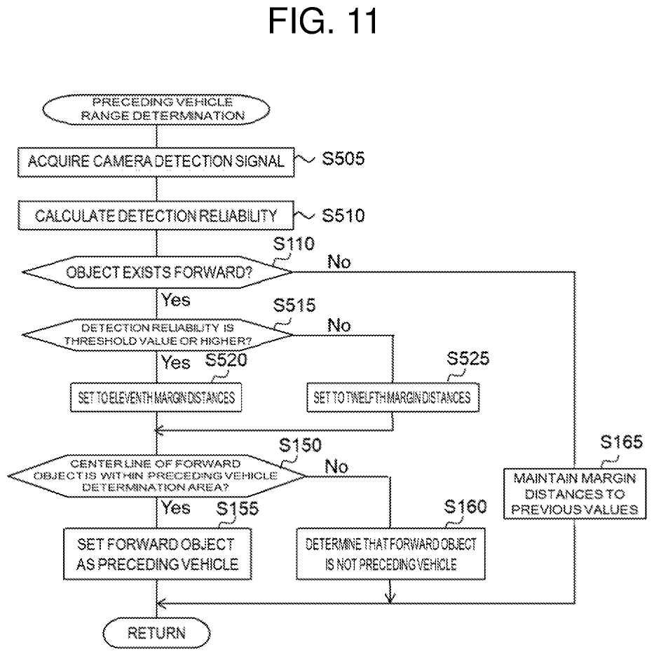

FIG. 11 is a flowchart for illustrating a preceding vehicle determining routine executed by the preceding vehicle determining device 10 according to the fifth embodiment. In FIG. 11, the same steps as those of FIG. 5 are denoted by the same reference symbols. The routine of FIG. 11 is started when the preceding vehicle determining device 10 is activated, and is executed each time a predetermined period elapses.

When the preceding vehicle determining device 10 starts the routine of FIG. 11, in Step S505, the preceding vehicle determining device 10 first acquires the camera detection signal from the camera 21. The camera detection signal includes the detection accuracy information.

After that, in Step S510, the preceding vehicle determining device 10 calculates the detection reliability of an object from the detection accuracy information. After that, in Step S110, the preceding vehicle determining device 10 determines whether or not an object exists forward of the own vehicle.

When an object exists forward of the own vehicle, in Step S515, the preceding vehicle determining device 10 determines whether or not the detection reliability of the forward object is equal to or higher than a threshold value. When the detection reliability is equal to or higher than the threshold value, in Step S520, the preceding vehicle determining device 10 sets the margin distances Xml and Xmr to eleventh margin distances Xml11 and Xmr11, respectively. The eleventh margin distances Xml11 and Xmr11 are each, for example, 0.2 m. The lateral width Xa of the preceding vehicle determination area DA in this case is referred to as “eleventh lateral width Xa11.”

When the detection reliability is lower than the threshold value, in Step S525, the preceding vehicle determining device 10 sets the margin distances Xml and Xmr to twelfth margin distances Xml12 and Xmr12 longer than the eleventh margin distances Xml11 and Xmr11, respectively. The twelfth margin distances Xml12 and Xmr12 are each, for example, 1.0 m. The lateral width Xa of the preceding vehicle determination area DA in this case is referred to as “twelfth lateral width Xa12.” As a result, the twelfth lateral width Xa12 is set to a value smaller than the eleventh lateral width Xa11.

As described above, according to the preceding vehicle determining device 10 of the fifth embodiment, the determination area setting unit 13 calculates the detection reliability of an object, and increases the preceding vehicle determination area DA in the width direction of the own lane when the detection reliability is higher than the threshold value. Consequently, erroneous determination of the preceding vehicle due to a decrease in the detection reliability is suppressed.

In the fifth embodiment, the two types of the margin distances Xml and Xmr are set in accordance with the level of the detection reliability of the object, but the margin distances Xml and Xmr may be set to smaller values as the detection reliability of the object increases. That is, the preceding vehicle determination area DA may be increased in the width direction of the own lane as the detection reliability of an object increases. Consequently, erroneous determination of the preceding vehicle due to a decrease in the detection reliability is more suppressed.

As the camera 21, a device which has a function of analyzing a captured image to calculate the detection reliability of an object may be used. When such a device is used, the detection reliability is transmitted from the camera 21 to the signal acquisition unit 11. The determination area setting unit 13 acquires the detection reliability from the signal acquisition unit 11.

Further, the determination of whether or not an object is a continuous preceding vehicle, which is executed in the first embodiment, may be additionally executed by the preceding vehicle determining device 10 according to the fifth embodiment. When the determination of whether or not the object is a continuous preceding vehicle is to be added, it is only required to add a step of determining whether or not the object is a continuous preceding vehicle, for example, immediately before Step S515 of FIG. 11. After that, it is only required to determine whether or not the detection reliability is equal to or higher than the threshold value in each of the case in which the object is a continuous preceding vehicle and the case in which the object is not a continuous preceding vehicle.

Further, the determination of whether the object is a four-wheeled vehicle or a two-wheeled vehicle, which is executed in the first embodiment, may be additionally executed by the preceding vehicle determining device 10 according to the fifth embodiment. When the determination of whether or not the object is a four-wheeled vehicle or a two-wheeled vehicle is to be added, it is only required to add a step of determining whether or not the object is a four-wheeled vehicle, for example, as the subsequent step of the determination of Step S515 of FIG. 11. After that, it is only required to set the margin distances Xml and Xmr in each of the case in which the object is a four-wheeled vehicle and in which the object is a two-wheeled vehicle.

Moreover, in the preceding vehicle determining device 10 according to the fifth embodiment, as in the second embodiment, the signal acquisition unit 11 may acquire the signals from the object detection device 20 including the camera 21 and the radar 22. Moreover, the determination area setting unit 13 may set the preceding vehicle determination area DA at the time when another vehicle is detected by only the radar 22 to be narrower in the width direction of the own lane than the preceding vehicle determination area DA at the time when another vehicle is detected by at least the camera 21.

Further, in the preceding vehicle determining devices 10 according to the first embodiment to the fifth embodiment, the same values are set to the margin distance Xml on the left side and the margin distance Xmr on the right side, but different values may be set to the margin distance Xml on the left side and the margin distance Xmr on the right side.

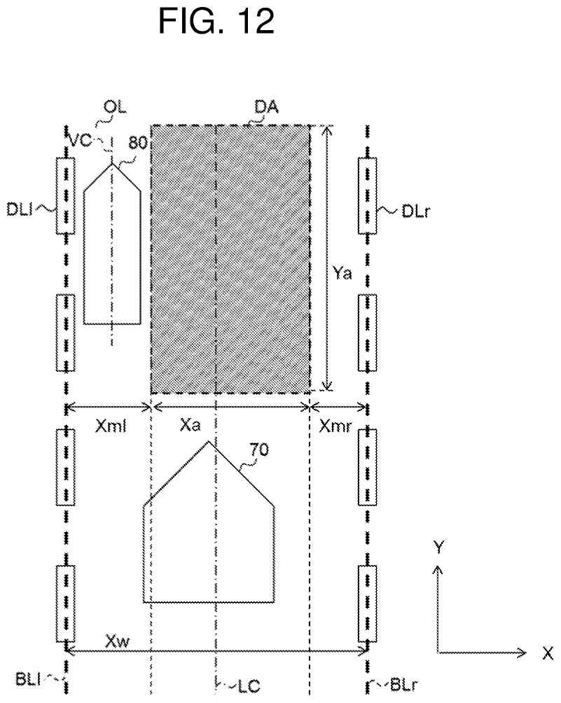

FIG. 12 is a plan view in a case in which the margin distance Xml on the left side and the margin distance Xmr on the right side are different from each other. With this configuration, a case in which a two-wheeled vehicle traveling adjacently to the left border BLl, a vehicle parking on a roadside on the left side with respect to the own lane OL, or the like is erroneously determined as a preceding vehicle is suppressed. Further, with this configuration, it is easy to determine, as a preceding vehicle, a vehicle which cuts into a front area of the own vehicle 70 from a lane on the right side of the own lane.

Moreover, in the preceding vehicle determining devices 10 according to the first embodiment to the fifth embodiment, each of the margin distances Xml and Xmr is set to the positive value, but each of the margin distances Xml and Xmr may be set to a negative value.

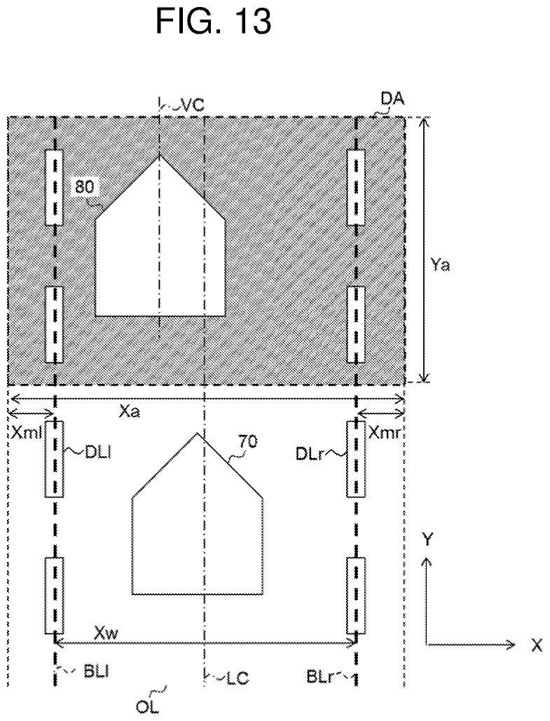

FIG. 13 is a plan view in a case in which the left margin distance Xml and the right margin distance Xmr take negative values. As in this case, the preceding vehicle determination area DA may be set on the outsides of the borders BLl and BLr of the own lane. With this configuration, when a preceding vehicle exists, the loss of the preceding vehicle is suppressed.

Moreover, in the preceding vehicle determining devices 10 according to the first embodiment to the fifth embodiment, each of the margin distances Xml and Xmr is set to the constant, but each of the margin distances Xml and Xmr may be changed in accordance with a relative distance between the own vehicle and an object.

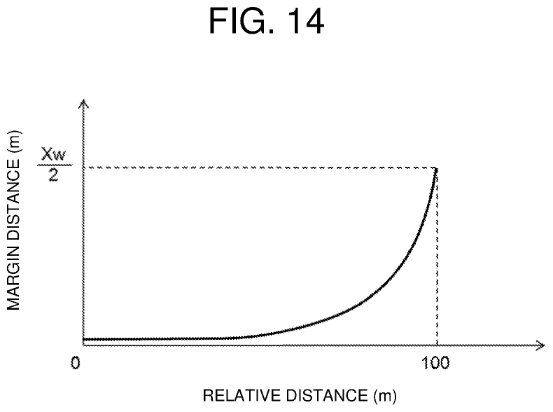

FIG. 14 is a graph for showing a relationship between the relative distance and the margin distance. In FIG. 14, each of the margin distances Xml and Xmr is maintained to a constant length in a range in which the relative distance is equal to or shorter than approximately 40 m. Each of the margin distances Xml and Xmr is set to increase in a form of a quadratic function as the relative distance increases in a range in which the relative distance is from approximately 40 m to approximately 100 m.

When the relative distance is 100 m, each of the margin distances Xml and Xmr is set to ½ of the width Xw of the own lane OL. That is, when the relative distance is 100 m, the lateral width Xa of the preceding vehicle determination area DA is set to 0.

The detection accuracy of the object detection device, such as the camera 21 or the radar 22, decreases as an object to be detected exists farther. However, with this configuration, as the relative distance to an object existing far increases, the lateral width Xa of the preceding vehicle determination area DA is reduced. Consequently, a case in which a far object is erroneously determined as a preceding vehicle is suppressed.

Moreover, in the preceding vehicle determining devices 10 according to the first embodiment to the fifth embodiment, the preceding vehicle determining unit 14 sets another vehicle 80 as a preceding vehicle when the center line VC of the another vehicle 80 in the width direction is positioned within the preceding vehicle determination area DA. However, the preceding vehicle determining unit 14 may set another vehicle 80 as a preceding vehicle when even a part of the another vehicle 80 exists in the preceding vehicle determination area DA.

Moreover, in the preceding vehicle determining devices 10 according to the first embodiment to the fifth embodiment, one vehicle is detected forward of the own vehicle as another vehicle, but it is only required that candidates of the preceding vehicle be selected as described below when a plurality of detected vehicles exist forward of the own vehicle as other vehicles.

For example, the preceding vehicle determining device 10 according to the first embodiment executes the processing steps of from Step S115 to Step S160 for each detected object. After that, the preceding vehicle determining device 10 determines whether or not each detected object can be the candidate of the preceding vehicle. After that, the preceding vehicle determining device 10 is only required to select an object existing at a position closest to the own vehicle from the objects which can be the candidates of the preceding vehicle.

Each of the preceding vehicle determining devices 10 according to the second embodiment to the fifth embodiment executes the process of determining whether or not each detected object is a preceding vehicle in the same manner as that in the first embodiment. After that, the preceding vehicle determining device 10 determines whether or not each detected object can be the candidate of the preceding vehicle. After that, the preceding vehicle determining device 10 is only required to select an object existing at a position closest to the own vehicle from the objects which can be the candidates of the preceding vehicle.

Moreover, in the preceding vehicle determining devices 10 according to the first embodiment to the fifth embodiment, another vehicle is discriminated as a four-wheeled vehicle or a two-wheeled vehicle based on the lateral width of the another vehicle, but the method of discriminating another vehicle as a four-wheeled vehicle or a two-wheeled vehicle is not limited to this method. For example, the camera 21 may discriminate another vehicle as a four-wheeled vehicle or a two-wheeled vehicle based on characteristics of a shape of the another vehicle at the time when the detected another vehicle is viewed from backward, or may discriminate by another method.

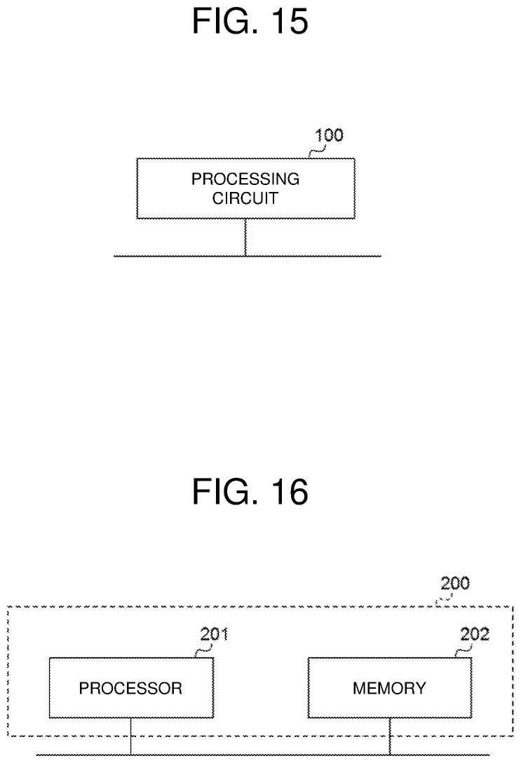

Further, each of the functions of the preceding vehicle determining devices 10 according to the first embodiment to the fifth embodiment is implemented by a processing circuit. FIG. 15 is a configuration diagram for illustrating a first example of the processing circuit which implements each of the functions of the preceding vehicle determining devices according to the first embodiment to the fifth embodiment. A processing circuit 100 of the first example is dedicated hardware.

Further, the processing circuit 100 corresponds to, for example, a single circuit, a complex circuit, a programmed processor, a processor for a parallel program, an application specific integrated circuit (ASIC), a field programmable gate array (FPGA), or a combination thereof. Further, the respective functions of the preceding vehicle determining devices may be implemented by individual processing circuits 100, or the functions may be collectively implemented by the processing circuit 100.

Further, FIG. 16 is a configuration diagram for illustrating a second example of the processing circuit which implements each of the functions of the preceding vehicle determining devices according to the first embodiment to the fifth embodiment. A processing circuit 200 of the second example includes a processor 201 and a memory 202.

In the processing circuit 200, the functions of the preceding vehicle determining devices are implemented by software, firmware, or a combination of software and firmware. The software and the firmware are described as programs to be stored in the memory 202. The processor 201 reads out and executes the programs stored in the memory 202, to thereby implement the respective functions.

The programs stored in the memory 202 can also be regarded as programs for causing a computer to execute the procedure or method of each of the above-mentioned components. In this case, the memory 202 corresponds to, for example, a nonvolatile or volatile semiconductor memory, such as a random access memory (RAM), a read only memory (ROM), a flash memory, an erasable programmable read only memory (EPROM), or an electrically erasable and programmable read only memory (EEPROM). Further, a magnetic disk, a flexible disk, an optical disc, a compact disc, a mini disc, a DVD, or the like also corresponds to the memory 202.

The function of each component described above may be implemented partially by dedicated hardware, and partially by software or firmware.

In this way, the processing circuit can implement the function of each of the above-mentioned components by hardware, software, firmware, or a combination thereof.

### REFERENCE SIGNS LIST

10 preceding vehicle determining device, 11 signal acquisition unit, 12 border setting unit, 13 determination area setting unit, 14 preceding vehicle determining unit, 20 object detection device, 21 camera, 22 radar, 30 travel control unit, 40 vehicle state quantity sensor, 41 vehicle speed sensor, 42 yaw rate sensor, 70 own vehicle, 80 another vehicle, 100, 200 processing circuit, 201 processor, 202 memory, BLl, BLr border, DA preceding vehicle determination area, DLl, DLr road dividing line, OL own lane (lane), LC center of lane, VC center line of another vehicle in width direction, Xa lateral width of preceding vehicle determination area, Xml, Xmr margin distance, Xw width of own lane (lane), Ya longitudinal width of preceding vehicle determination area

1. A preceding vehicle determining device, comprising:
a signal acquisition circuitry to acquire a signal from an object detector to detect an object forward of an own vehicle;
a border setting circuitry to set a border of a lane on which the own vehicle is traveling;
a determination area setting circuitry to set a preceding vehicle determination area being an area forward of the own vehicle based on at least one piece of information out of vehicle type information being information on a type of another vehicle detected by the object detector, device type information being information on a type of the object detector, detection state information being information on a state of detection of the object by the object detector, or preceding vehicle information being information on a vehicle set as a preceding vehicle in previous processing, and based on the border set by the border setting circuitry; and
a preceding vehicle determining circuitry to determine whether the another vehicle is to be set as the preceding vehicle based on a position of the another vehicle with respect to the preceding vehicle determination area.

2. The preceding vehicle determining device according to claim 1, wherein the determination area setting circuitry is configured to:
set, as a lateral width of the preceding vehicle determination area, a length obtained by subtracting, from a width of the lane, a margin distance being a distance from the border in a width direction of the lane, and
change the margin distance based on at least one piece of information out of the vehicle type information, the device type information, the detection state information, or the preceding vehicle information, to thereby set the preceding vehicle determination area.

3. The preceding vehicle determining device according to claim 1, wherein the determination area setting circuitry is configured to set the preceding vehicle determination area at time when the another vehicle is continuously determined as the preceding vehicle by the preceding vehicle determining circuitry to be wider in a width direction of the lane than the preceding vehicle determination area at time when the another vehicle is not continuously determined as the preceding vehicle by the preceding vehicle determining circuitry.

4. The preceding vehicle determining device according to claim 1, wherein the determination area setting circuitry is configured to set the preceding vehicle determination area at time when the type of the another vehicle is a two-wheeled vehicle to be narrower in a width direction of the lane than the preceding vehicle determination area at time when the type of the another vehicle is a four-wheeled vehicle.

5. The preceding vehicle determining device according to claim 1, wherein, when the object detector includes a camera and a radar, the determination area setting circuitry is configured to set the preceding vehicle determination area at time when the another vehicle is detected by only the radar to be narrower in a width direction of the lane than preceding vehicle determination area at time when the another vehicle is detected by at least the camera.

6. The preceding vehicle determining device according to claim 1,
wherein the border setting circuitry is configured to estimate the border based on a travel speed of the own vehicle and a yaw rate of the own vehicle when a road dividing line is not detected by the object detector, and
wherein the determination area setting circuitry is configured to set the preceding vehicle determination area at time when the road dividing line is not detected by the object detector to be narrower in a width direction of the lane than the preceding vehicle determination area at time when the road dividing line is detected by the object detector.

7. The preceding vehicle determining device according to claim 1,
wherein the border setting circuitry is configured to estimate the border based on a travel speed of the own vehicle and a yaw rate of the own vehicle when a road dividing line is not detected by the object detector, and
wherein, when the another vehicle is continuously determined as the preceding vehicle by the preceding vehicle determining circuitry, the determination area setting circuitry is configured to set the preceding vehicle determination area at time when the road dividing line is not detected by the object detector to be wider in a width direction of the lane than the preceding vehicle determination area at time when the road dividing line is detected by the object detector.

8. The preceding vehicle determining device according to claim 1, wherein the determination area setting circuitry is configured to increase the preceding vehicle determination area in a width direction of the lane as a detection reliability being a degree of a probability of a detection position and a detection shape of the object increases.

9. A preceding vehicle determining program for causing a computer to execute:
acquiring a signal from an object detector to detect an object forward of an own vehicle;
setting a border of a lane on which the own vehicle is traveling;
setting a preceding vehicle determination area being an area forward of the own vehicle based on at least one piece of information out of vehicle type information being information on a type of another vehicle detected by the object detector, device type information being information on a type of the object detector, detection state information being information on a state of detection of the object by the object detector, or preceding vehicle information being information on a vehicle set as a preceding vehicle in previous processing, and based on the border set in the border setting processing; and
determining whether the another vehicle is to be set as the preceding vehicle based on a position of the another vehicle with respect to the preceding vehicle determination area.
